(19) United States
(12) Patent Application Publication
(10) Pub. No.: US 2011/0156304 A1
(43) Pub. Date: Jun. 30, 2011

(54) Die Tool Production Methods Utilizing Additive Manufacturing Techniques

(76) Inventors: Bryant Walker, Palm City, FL (US); Raymond Walker, Port Saint Lucie, FL (US); Ralph Anderson, Palm Beach Gardens, FL (US)

(21) Appl. No.: 12/981,910

(22) Filed: Dec. 30, 2010

Related U.S. Application Data
(60) Provisional application No. 61/291,528, filed on Dec. 31, 2009.

(51) Int. Cl. B29C 41/38; B29C 33/38; B29C 41/02; B29C 41/46; B29C 41/52; B23P 19/04

(52) U.S. Cl. 264/219; 425/470; 264/314; 29/460

(57) ABSTRACT

A method for producing a die tool includes forming a substantially complete face plate of the die tool utilizing an additive manufacturing process, forming a support structure of the die tool independently from the face plate, and coupling the face plate with the support structure. A die tool for use in composite manufacturing includes a face plate and stiffening structure integrated with the face plate. The stiffening structure forms one or more hollow channels that transport fluid for heating or cooling during the composite manufacturing. A die tool for use in composite manufacturing includes a face plate and a support structure coupled with the face plate. A ratio of weight of the support structure to weight of the die tool is less than 0.33.

### CROSS-REFERENCE TO RELATED APPLICATIONS

This application claims priority to U.S. Provisional Patent Application Ser. No. 61/291,528, filed 31 Dec. 2009, which is incorporated by reference herein.

### U.S. GOVERNMENT RIGHTS

This invention was made with Government support under SBIR Phase II Contract No. FA8650-07-C-5305 awarded by the Air Force Research Laboratory. The Government has certain rights in this invention.

### BACKGROUND

Polymer Matrix Composite (“PMC”) manufacturing of large components (e.g., aircraft engine housings and panels for aircraft exteriors) generally involves layering raw PMC material called “prepreg,” typically a tape of reinforcing fibers or fabric that is saturated or “pre-impregnated” with an uncured matrix or resin, onto a die tool. At this stage, the PMC material is called a “layup.” The die tool includes a surface (the “die face”) mimicking the desired final shape of the composite part, and which extends beyond the final shape. Holes are carefully drilled in the die face around the edges of the final shape. A cellophane-like bagging material that can withstand high temperatures is placed over the layup, extending beyond the drilled holes, and seals to the die tool. A vacuum is drawn through the drilled holes to pull the PMC material tightly to the surface (i.e., atmospheric pressure pushes down on the bagging material and PMC layup against the die tool surface). Then the die tool and PMC material are first brought up to a high temperature to cure the PMC material, setting its shape, and then returned to room temperature for removal of the PMC component. The temperature schedule may be lengthy and tightly controlled to minimize any expansion and/or contraction mismatches between the die tool and PMC component. Any unintended leak in the die face can draw air through the leak to form bubbles in the front surface of the layup, leading to surface voids or “blisters” in the composite part, which usually cannot be repaired, so that the part must be scrapped.

To minimize tool expansion/contraction and deformation during heat cycles, the die tool is often specified for construction in Invar, an iron/nickel alloy with very low thermal expansion. Such die tools for PMC manufacturing can be massive, and their construction can be expensive and time consuming. For example, a die tool for a jet engine housing might weigh about 3000 pounds, cost around $200,000 and take around 16 weeks to produce utilizing current methods. Furthermore, many current methods of producing die tools are only suitable for initial production of such tools, and are not easily adaptable for repair or modification of existing tools. In addition, many existing methods produce die tooling by first making an object that holds an outline of the final, intended tool and then incrementally removing material until the final tool's outline is reached; such techniques inherently convert large percentages of the initial raw material to scrap. For die tools that are large and/or made of expensive materials, the low material utilization of such techniques adds significantly to cost of the final product.

FIGS. 1A, 1B and 1C illustrate prior art steps of forming a die tool for layup of PMC. Such die tools are normally built starting with an internal support structure created to support external faces of the tool, which are layered on and machined down to final dimensions. It is generally considered impractical to simply fabricate or weld together external faces to form complex shapes without such support structure, due to the difficulty of positioning the faces relative to one another in space, combined with the need for the final surface to be unitary and leak tight.

FIG. 1A is an elevational view of a portion 12 of a prior art support structure. Portion 12 includes bracing 14 that is typically formed of metal bars or plates, or components that are mechanically formed by casting, or by bending or punching sheet metal, and are typically hand welded together. Portion 12 includes features 16, sometimes called “crowns,” that are located close to an intended final surface of the die tool and are utilized to locate the final surface in space, and as attachment points. FIG. 1B is a perspective view of a support structure 10. Support structure 10 includes portions 12, 12′, 12″ and 12″′ positioned and joined with connecting pieces 18 to hold them in place relative to one another, and is sometimes called an “eggcrate.” Connecting pieces 18 include additional crowns 16, as shown. Support structure 10 provides structural stability for the die tool during its own manufacturing and in its end use, in particular through heat cycles that characterize PMC manufacturing.

FIG. 1C is a perspective view of support structure 10 with some rough tool face elements 20 added. Rough tool face elements 20 are typically 1″ to 2″ thick and are hand welded to crowns 16 and to each other; any gaps between rough tool face elements 20 must be filled by hand welding because the final die tool must be vacuum tight. Filling gaps between elements 20 is both labor intensive and problematic. Of the roughly 16 weeks required to produce the final die tool, 3-4 weeks may be required to produce the eggcrate and 4-5 weeks may be required to fabricate and weld the rough tool face elements to the eggcrate, which must be done serially, so that the net total time required may be about 8 weeks. Furthermore, leaks in the die tool are generally believed to originate at the gaps and/or where weld material adjoins plate material of elements 20, and such leaks are sometimes not initially present, but open up when the tool is subjected to repeated thermal cycles. Thus, a die that is thought to be good when first used can have leaks open up later, with severe consequences for production cost and schedules.

A portion denoted as A in FIG. 1C is shown in further detail in FIGS. 1D and 1E to illustrate how a final die tool surface for PMC manufacturing is typically produced in the prior art. FIG. 1D is an enlarged, elevational view of portion A in FIG. 1C after rough tool face elements 20 have been added and before machining of a final tool face. Rough tool face elements 20 are welded to crowns 16 with weld material 22, as shown. An intended final tool surface 24 is located within each rough tool face element 20. FIG. 1E is an enlarged, elevational view of portion A in FIG. 1C after machining is complete. In FIG. 1E, material of rough tool face elements 20 and weld material 22 has been removed down to surface 24, to form final tool face elements 20′ and weld material 22′.

Producing a final die tool surface in the manner outlined above may lead to waste of raw material (e.g., the material of rough tool face elements 20 and weld material 22 that is outside surface 24) since that material is utilized with the intention of its later removal. Furthermore, when a large die tool (e.g., several feet or more in dimension) is produced, weight of the rough tool face elements may be such that the support structure must be considerably “overbuilt,” that is, extra material must be utilized in the “eggcrate” (e.g., in bracing 14, FIG. 1A and connecting pieces 18, FIG. 1B) to support the tool face elements until machining reduces their weight. In the example of a die tool for a jet engine housing discussed above, the 3000 pound total weight of the finished die tool would typically include about 1500 pounds in the “eggcrate” and 1500 pounds in the finished face plate (the initial weight of the rough tool face elements is even higher before significant metal is machined away to produce the final tool face). Therefore for the prior art technology, a ratio of weight of the support structure to weight of the finished die tool may be about 1500/3000, or 0.5, although this ratio may vary somewhat, in an approximate range of 0.4 to 0.7. A thermal mass of the finished die tool increases according to weight of the support structure, and a high ratio of weight of the support structure to weight of the finished die tool tends to increase thermal mass. High thermal mass of the finished die tool is generally undesirable during PMC manufacturing as it increases time and energy required to heat and/or cool the tool as needed for PMC curing. Much of the machining to remove material to produce the final tool surface is typically done utilizing large milling machines, but some finishing may be done by hand and therefore may be very expensive and time consuming. Finally, if such machining penetrates below the intended final tool surface, additional raw material is typically added back to the die tool (e.g., by welding) and machining is typically repeated in order to generate the finished die tool surface.

### SUMMARY

In an embodiment, a method for producing a die tool includes forming a substantially complete face plate of the die tool utilizing an additive manufacturing process, forming a support structure of the die tool independently from the face plate, and coupling the face plate with the support structure to form the die tool.

In an embodiment, a die tool for use in composite manufacturing includes a face plate and stiffening structure integrated with the face plate. The stiffening structure forms one or more hollow channels configured for transport of fluid for one of heating and cooling during the composite manufacturing.

In an embodiment, a die tool for use in composite manufacturing includes a face plate and a support structure coupled with the face plate. A ratio of weight of the support structure to weight of the die tool is less than 0.33.

In an embodiment, a method of producing a die tool that includes a face plate and a support structure is improved by independently forming a substantially complete face plate of the die tool, utilizing an additive manufacturing process, and a support structure of the die tool. The face plate is coupled with the support structure to form the die tool.

In an embodiment, a method of producing a polymer matrix composite product includes forming a substantially complete face plate of a die tool utilizing an additive manufacturing process. The face plate has stiffening structure, including one or more hollow channels, on a backside thereof. The method also includes applying raw polymer matrix composite material to a frontside of the face plate, and flowing a fluid through the one or more hollow channels to heat or cool the die tool, thereby curing the polymer matrix composite material to form the product.

In an embodiment, a method of producing a polymer matrix composite product includes providing a die tool that includes a face plate having stiffening structure that forms one or more hollow channels, on a backside thereof. The method also includes applying raw polymer matrix composite material to a frontside of the face plate and placing a vacuum bag atop the polymer matrix composite material. The method further includes sealing a mating enclosure to the face plate, such that a seal between the face plate and the mating enclosure circumscribes a periphery of the polymer matrix composite material, to form a cavity between the face plate and the mating enclosure, and pressurizing the cavity so as to increase pressure exerted by the vacuum bag against the polymer matrix composite material and the face plate, while the polymer matrix composite material cures to form the product.

### BRIEF DESCRIPTION OF DRAWINGS

FIG. 1A is an elevational view of a portion of a prior art support structure.

FIG. 1B is a perspective view of the support structure of FIG. 1A.

FIG. 1C is a perspective view of the support structure of FIG. 1A with some rough tool face elements added.

FIGS. 1D and 1E illustrate how a final die tool surface for polymer composite manufacturing is typically produced in the prior art.

FIG. 2 is a flowchart of one exemplary method for producing a die tool, according to an embodiment.

FIG. 3 illustrates further detail and optional substeps of the method of FIG. 2, according to an embodiment.

FIG. 4A schematically illustrates, in elevational view, an example of the beginning of die tool production utilizing an additive manufacturing process, according to an embodiment.

FIG. 4B schematically illustrates, in elevational view, a portion of a tool face being built up on the deposition substrate shown in FIG. 4A.

FIG. 4C schematically illustrates, in perspective view, a portion of a tool face being further built up on the deposition substrate shown in FIG. 4A.

FIG. 5 shows a tool face resulting from the manufacturing steps illustrated in FIGS. 4A, 4B and 4C.

FIG. 6 shows a support structure for the tool face of FIG. 5 that may be fabricated independently of the tool face, according to an embodiment.

FIG. 7 is an elevational view of the tool face of FIG. 5 welded in place onto the support structure of FIG. 6 to form a finished die tool, according to an embodiment.

FIG. 8 schematically illustrates a manufacturing cell configured for additive manufacturing of a face plate for PMC manufacturing, according to an embodiment.

FIG. 9A is a top perspective view of a frontside surface of a face plate for PMC manufacturing, according to an embodiment.

FIG. 9B is a bottom perspective view of a backside surface of the face plate of FIG. 9A.

FIG. 10 is a bottom perspective view of a backside surface of a face plate for PMC manufacturing, according to an embodiment.

FIG. 11 shows a support structure 550 that includes attachment points, according to an embodiment.

FIGS. 12A through 12D illustrate buildup of closed channels on a backside of a face plate, according to an embodiment.

FIG. 13A is a flowchart that shows a method of generating registration features, according to an embodiment.

FIG. 13B is a flowchart that shows another method of generating registration features, according to an embodiment.

FIG. 14 is a flowchart of a manufacturing method that utilizes in-process feedback to modify an additive manufacturing process to correct for positional shift in a face plate being built, according to an embodiment.

FIG. 15 is a perspective view illustrating a PMC panel having a damaged area.

FIG. 16 shows the panel of FIG. 15 with the damaged area machined out to present a “clean” hole through the panel, and an area identified as a target area for a custom die face, according to an embodiment.

FIG. 17A is a perspective view of a custom die tool having a repair surface, according to an embodiment.

FIG. 17B is a perspective view of die tool of FIG. 17A that shows its backside, including an isogrid stiffening structure integrated therewith, according to an embodiment.

FIG. 18 shows the die tool of FIGS. 17A and 17B in place over the target area of the PMC panel shown in FIG. 16.

FIG. 19 shows a die tool being utilized to fabricate a custom patch for the panel of FIG. 15.

FIG. 20 shows the patch of FIG. 19 installed in the panel of FIG. 15.

FIG. 21 illustrates a die tool being utilized in a PMC manufacturing process, according to an embodiment.

FIG. 22A, FIG. 22B and FIG. 22C illustrate cross-sectional details of the die tool of FIG. 21, as used during PMC manufacturing.

FIG. 23 is a flowchart of a method for producing a polymer matrix composite product.

### DETAILED DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

“Additive” processes or manufacturing are defined herein as techniques that add metal by depositing the metal onto a workpiece at a specific point that can be adjusted by adjusting the tool or moving the workpiece. Additive processes include, but are not limited to, direct digital manufacturing (“DDM”), electron beam deposition (“EBD”), electron beam free form fabrication (“EBFFF”), electron beam additive manufacturing (“eBAM”), laser powder deposition, wire arc plasma spray, tungsten inert gas (“TIG”) and metal inert gas (“MIG”) deposition. “Additive” processes as utilized herein specifically exclude (1) unitary formation processes such as casting or molding, (2) “blanket” deposition processes that substantially add a layer of material to an object in a single operation, and (3) processes that join existing objects, such as welding.

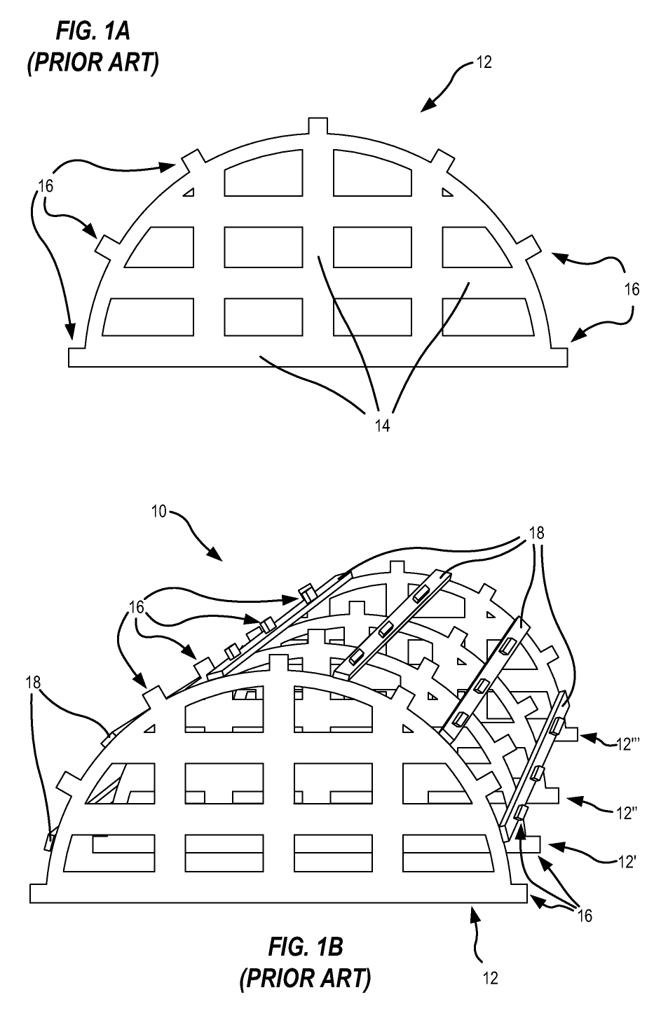

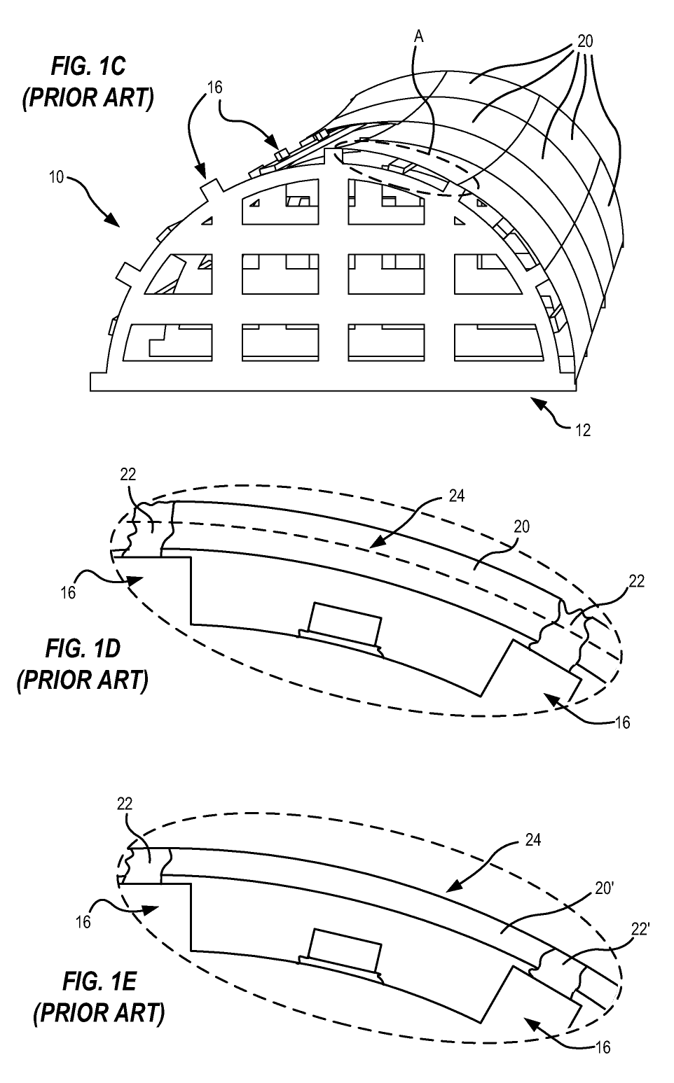

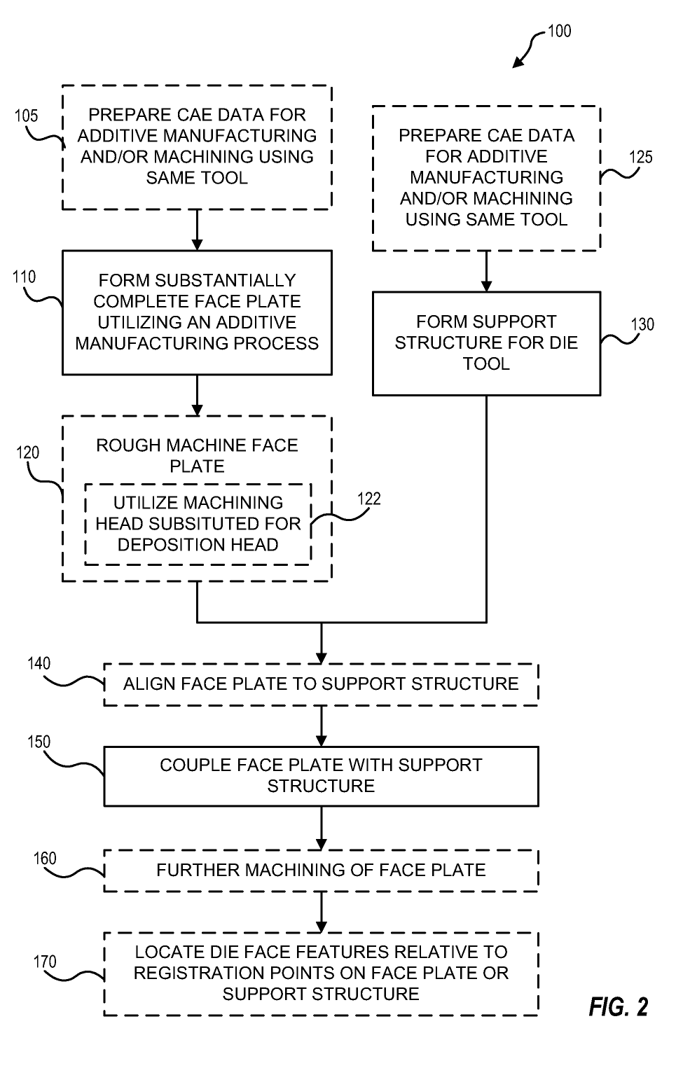

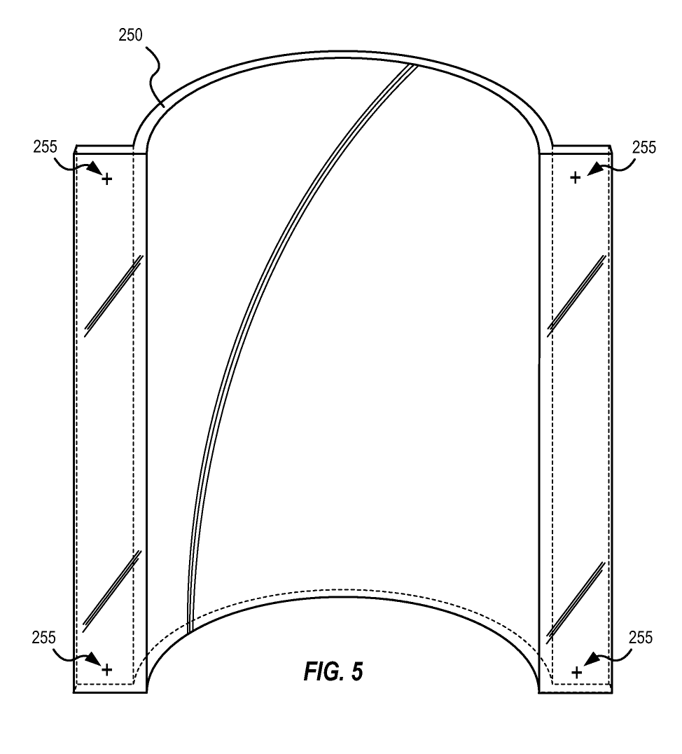

FIG. 2 is a flowchart of a method 100 for producing a die tool. An optional step 105 prepares computer-aided engineering data (“CAE” data) for additive manufacturing and/or for machining utilizing the same tool that performs the additive manufacturing. An example of step 105 is taking CAE data representing a solid model of a face plate of the die tool and “slicing” it into pieces whose thickness corresponds to individual deposition passes of an additive manufacturing deposition head. Step 110 of method 100 forms a substantially complete face plate of the die tool utilizing an additive manufacturing process. An example of step 110 is producing face plate 250 (see FIG. 5). The face plate is formed in additive manufacturing equipment that builds up the face plate by utilizing a deposition head to build up the face plate. Because the additive manufacturing process can generate relatively thin (e.g., 0.25″-0.5″) and complex shapes in space with good accuracy, the face plate may utilize less raw material and therefore be lighter than rough face plates produced using prior art techniques (e.g., as shown in FIGS. 1C and 1D), and is formed without a support structure in place during step 110. For example, with current additive manufacturing technology, the face plate may be manufactured with an average thickness of 0.375″+0.200/−0.125″, although it is contemplated the target thickness and tolerances may be reduced in the future, commensurate with improvements in consistency of additive manufacturing and process control techniques associated therewith. The description herein of the face plate being substantially complete means that nearly all of the final surface of the face plate is within the built-up face plate. However, elements such as fixturing, alignment features and parts of the face plate that are not optimally made utilizing additive manufacturing (e.g., due to awkward shapes and/or fine geometries) may not be present. An optional step 120 performs rough machining of the face plate before the face plate couples with the support structure. In a further optional substep 122, such rough machining is performed without removing the face plate from the additive manufacturing equipment, by substituting a machining head for the deposition head.

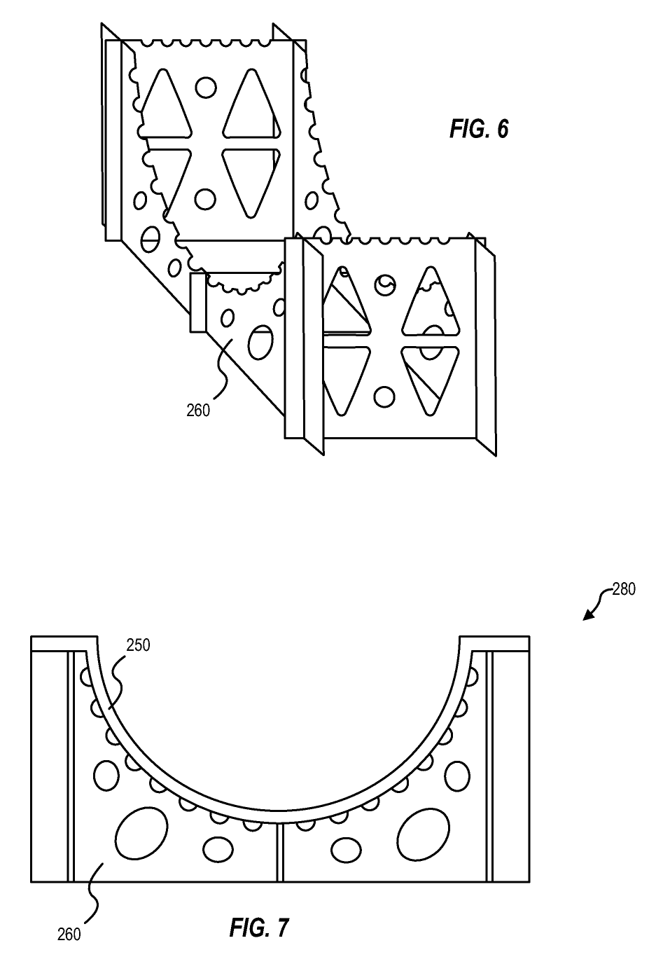

In parallel with steps 105-120 that produce the face plate, another set of steps in method 100 produces a support structure. Step 130 of method 100 forms the support structure for the die tool. Examples of step 130 include producing support structure 10 (see FIG. 1B) or support structure 260 (see FIGS. 6 and 7). The support structure may be a full “eggcrate” type structure (e.g., support structure 10) made by assembling and/or welding together bracing structure, connecting pieces and the like, or a simple version thereof, like support structure 260. Alternatively, it may be a unitary structure made utilizing an additive manufacturing process. In the latter case, an optional step 125 prepares computer-aided engineering data (“CAE” data) for additive manufacturing and/or for machining utilizing the same tool that performs the additive manufacturing. Analogously to step 105, an example of step 125 is taking CAE data representing a solid model of a support structure of the die tool and “slicing” it into pieces whose thickness corresponds to individual deposition passes of an additive manufacturing deposition head.

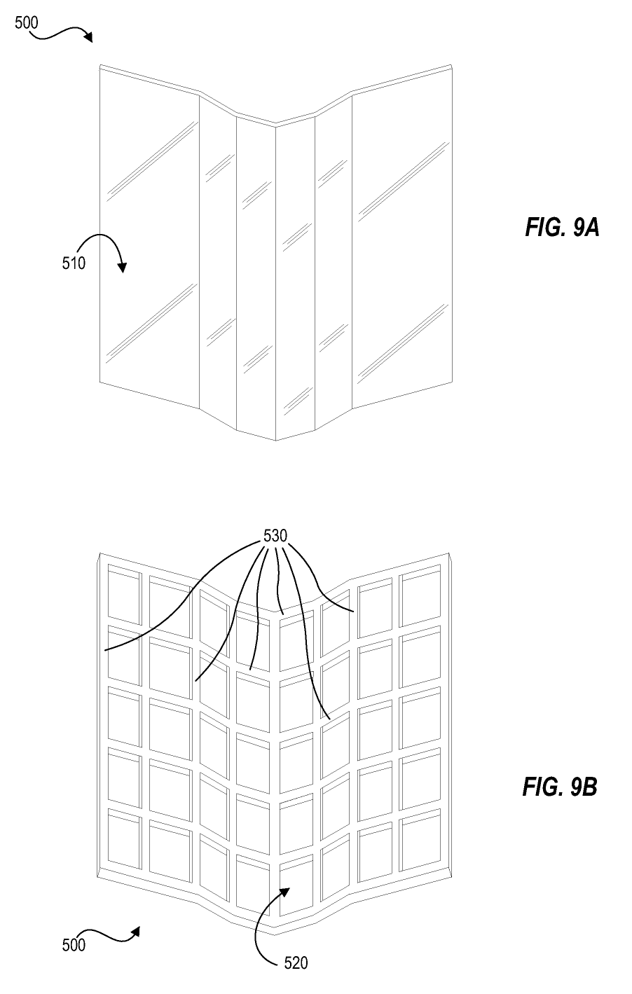

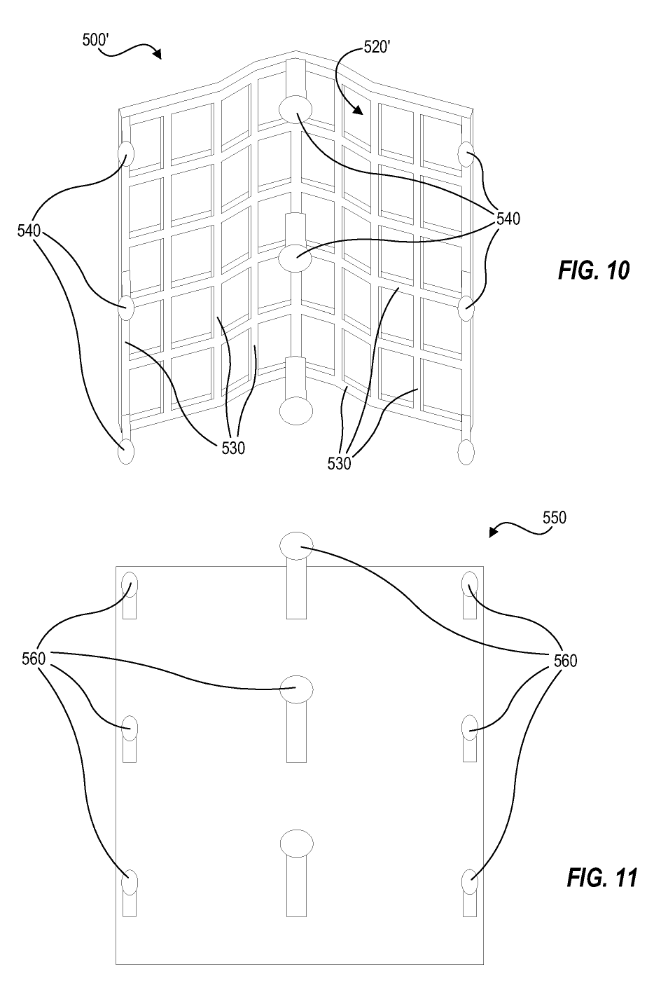

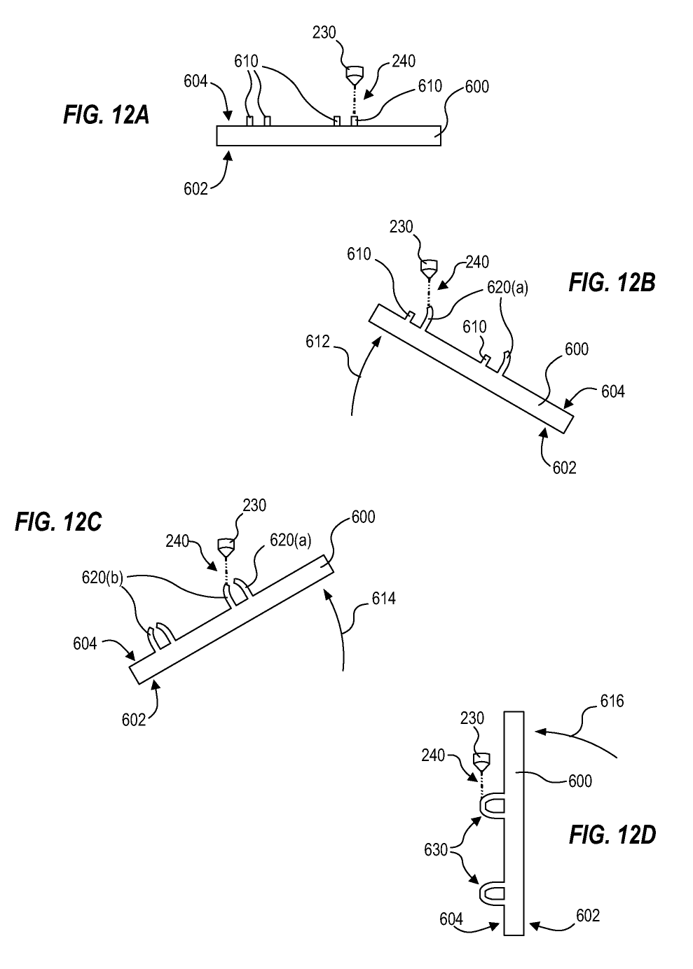

Independent of how the support structure is manufactured, it may be an interchangeable support structure, that is, a support structure built with support points arranged to mate with corresponding support points of more than one face plate (see, e.g., FIGS. 10 and 11). Also, since the face plate that corresponds to the support structure may be much lighter and/or stiffer than rough face plates utilized in prior art techniques, the support structure may also be much lighter than support structure for a corresponding prior art face plate. The face plate will have reduced thickness as compared to prior art face plates, which will reduce weight, but may have stiffening structure on a backside of the face plate (see FIGS. 9B and 12A through 12D). (In the present document, the “frontside” of a face plate is the side that will come into contact with prepreg material during PMC manufacturing, and the “backside” is the opposite surface of the face plate.) The stiffening structure will add some weight back as compared to prior art face face plates, but the support structure can be much lighter because the face plate is attached in a near-final form, reducing the weight that must be borne by the support structure as compared to the full weight of thick plates that are used to form the prior art face plates. For example, in an embodiment herein, a die tool used to produce the same jet engine housing discussed above might only weigh 2000 pounds, of which about 1500 pounds would be the weight of the face plate and only 500 pounds would be the weight of the support structure. In this case, a ratio of weight of the support structure to weight of the finished die tool is 500/2000, or 0.25. For other finished die tools, according to embodiments herein, a ratio of the weight of the support structure to the weight of the finished die tool is less than 0.33 and in certain cases may be 0.20, 0.10 or less. A significantly reduced ratio of the weight of the support structure to the weight of the finished die tool provides unique advantages during manufacturing in the form of reduced energy costs and manufacturing time related to heating and cooling the die tool.

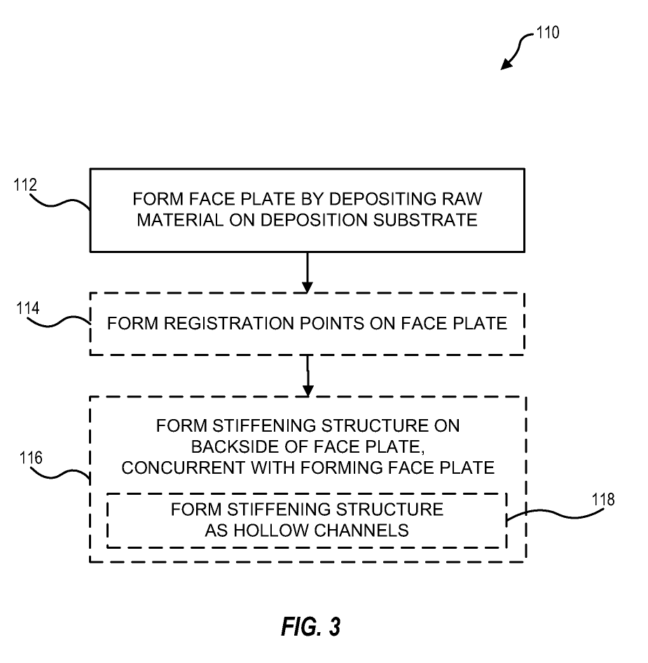

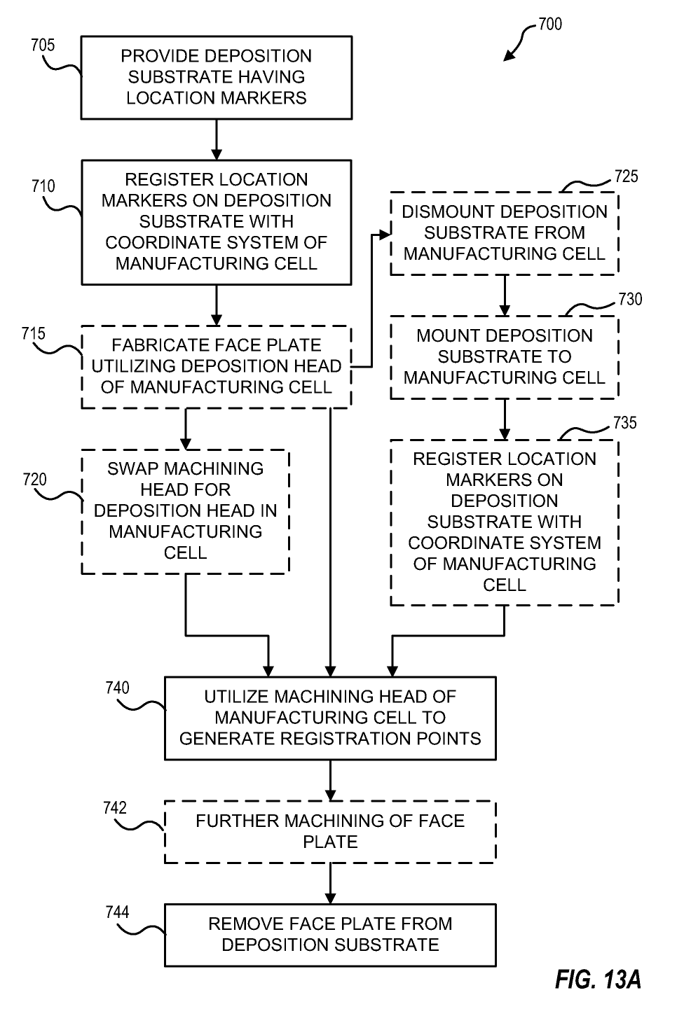

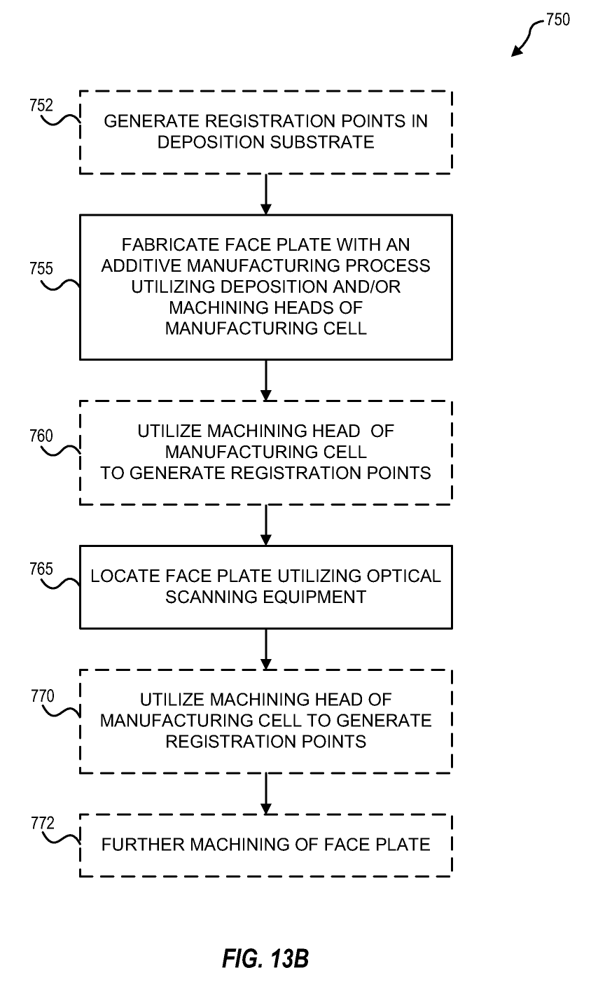

Successful use of a die tool for PMC manufacturing may rely in part on ability of an automated tape-laying machine to register with high mechanical precision to one or more known locations, relative to the contours of the die face, on the die tool. Such known locations are referred to herein as “registration features.” Registration features can be, for example, “datum pads” that form the “feet” of a die tool, and that have known positions relative to the die face. Alternatively, registration features may be machined into the face plate, perhaps in a peripheral region thereof, where features of the registration features will not be in contact with prepreg when used in PMC manufacturing. An optional step 140 aligns the face plate to the support structure utilizing registration features of the face plate. Optional step 140 may be utilized for example when such registration features are built into the face plate and/or support structure, as described in step 114 below (FIG. 3), and in FIGS. 13A and 13B. Step 150 couples the face plate with the support structure. An example of step 150 is welding face plate 250 to support structure 260 (see FIG. 7). Another example of step 150 is removably coupling face plate 500′ with support structure 550, see FIGS. 10 and 11. The die tool may be considered finished after step 150, or further machining of the face plate may be performed in an optional step 160 to reach final tolerances of the face plate dimensions. An example of step 160 is machining face plate 250 (FIG. 7) to final tolerances. Whether machining is performed in step 120, 160 or both, the face plate formed in step 110 is generated with sufficient accuracy that little raw material is removed to form the final die tool; typical raw material utilization for method 100 (counting both the face plate, the support structure and any materials utilized in step 150 to couple them) is greater than 90% and may be greater than 95%. An optional step 170 locates die face features relative to registration features on the face plate or on the support structure. Examples of step 170 are discussed below in connection with FIGS. 13A and 13B.

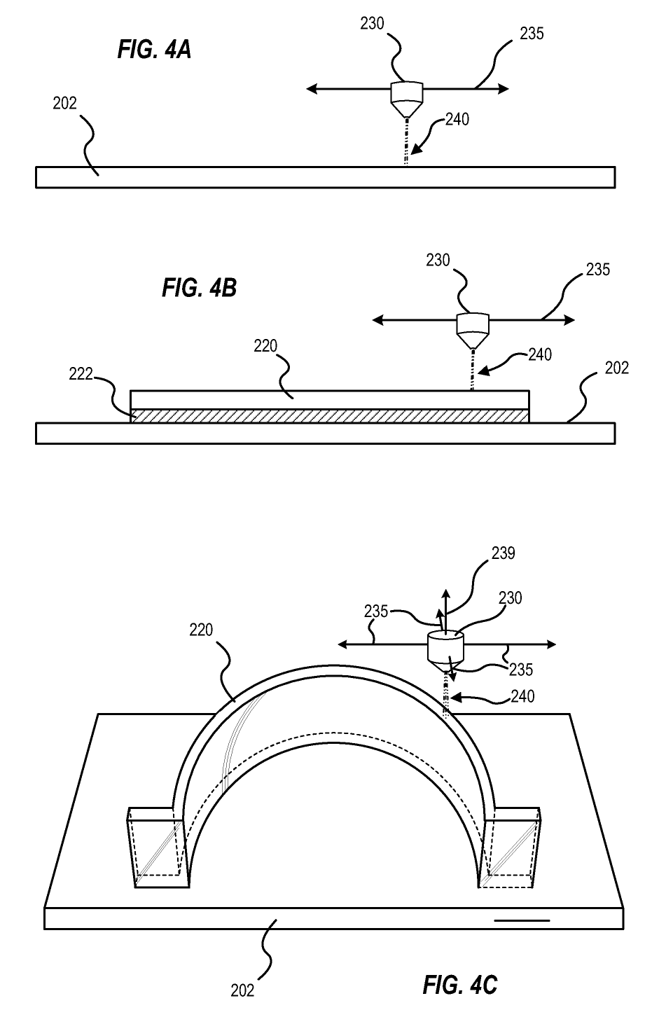

FIG. 3 illustrates further detail and optional substeps of step 110 of method 100 (FIG. 2), according to an embodiment. Substep 112 deposits raw material on a deposition substrate (e.g., substrate 202, see FIGS. 4A, 4B and 4C) to “build up” the face plate. Optional substep 114 forms registration features on a backside of the face plate, concurrent with forming the face plate. An example of substep 114 is forming registration features 540, FIG. 10. Optional substep 116 forms stiffening structure on the backside of the face plate, concurrent with forming the face plate. An example of substep 116 is forming stiffening ribs 530, see FIG. 9B. In a further optional substep 118, the stiffening structure formed in substep 116 forms hollow channels that can be utilized during PMC manufacturing for heating or cooling liquids to heat or cool, respectively, the die face during composite fabrication as described further below in connection with FIGS. 12A through 12D. It is appreciated that substeps 114, 116 and/or 118 are not necessarily performed in the sequence shown but are performed in any sequence and any number of times according to the face plate structure being built.

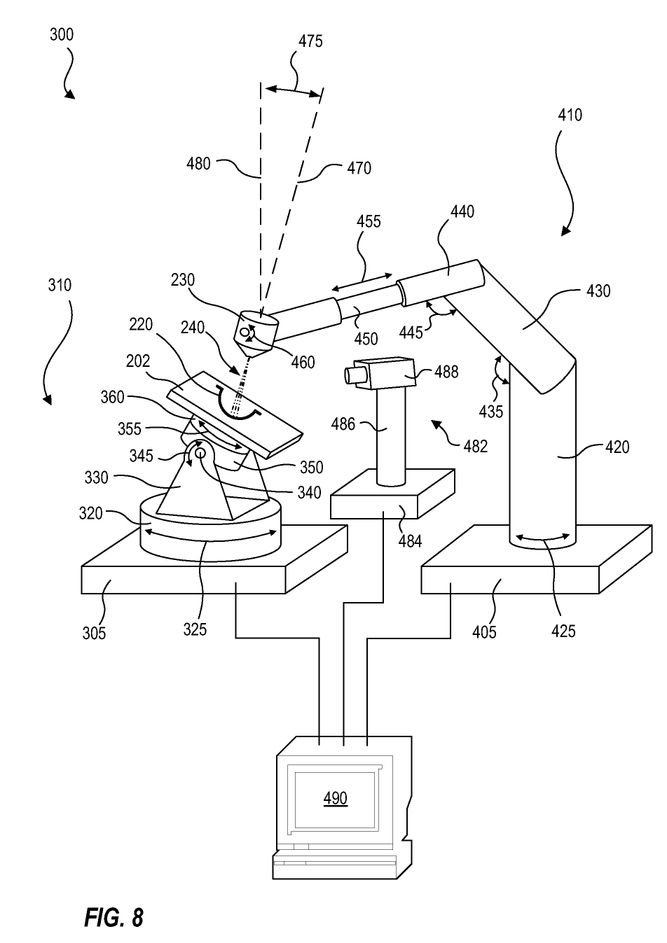

FIGS. 4A, 4B and 4C schematically show features of additive manufacturing that are simplified in order to introduce additive manufacturing concepts. In particular, FIGS. 4A, 4B and 4C illustrate one possible arrangement of equipment and fixtures for motion control of a deposition head relative to a substrate, for additively manufacturing a face plate and associated structures, but arrangements providing more degrees of mechanical freedom may also be utilized (e.g., as shown in FIG. 8).

FIG. 4A schematically illustrates, in elevational view, an example of the beginning of die tool production utilizing an additive manufacturing process. A deposition head 230 deposits metal 240 onto a deposition substrate 202. Deposition head 230 moves back and forth in the direction of arrows 235 (that is, left and right as shown, also in and out of the page, not visible in the elevational view of FIG. 4A) to deposit metal in an intended shape of a face plate. Deposition head 230 may utilize any of several methods of deposition including but not limited to DDM, EBD, EBFFF, eBAM, laser powder deposition, wire arc plasma spray, TIG and/or MIG deposition. Metal 240 may be one of Invar, steel, titanium, copper or other material that can be formed by the additive manufacturing process. A die tool may also include different parts formed of two or more metals, such as one or more ductile and/or easily machinable metal utilized at surfaces over one or more structural elements that set the basic shape and thermal expansion properties of the tool. Because such tools may degrade over many thermal cycles (due to thermal mismatch between the materials tending to pull them apart at their interface) use of two or more metals may be especially useful for so-called “short run” dies that are only intended to be used to fabricate small numbers of composite parts.

FIG. 4B schematically illustrates, in elevational view, an example of die tool production just past the stage illustrated in FIG. 4A. A portion 220 of a face plate builds up on and is welded to deposition substrate 202. Between portion 220 and deposition substrate 202 is a “sacrificial” portion 222 that provides tool clearance for eventually cutting the finished face plate from deposition substrate 202.

FIG. 4C schematically illustrates, in perspective view, portion 220 continuing to be built up on deposition substrate 202 (FIGS. 4A, 4B). FIG. 4C thus shows the process of building a tool face utilizing the same deposition head and on the same substrate as in FIGS. 4A and 4B, with the tool face partially done. As deposition proceeds, deposition head 230 is controlled to move over substrate 202 as shown by arrows 235, and to move away from substrate 202 in the direction of arrow 239, so that the deposition head remains at an optimum height over the face plate being built up.

FIG. 5 shows a face plate 250 resulting from the manufacturing steps illustrated in FIGS. 4A, 4B and 4C, that is, after deposition of metal 240 builds face plate 250 to its final dimensions and face plate 250 is cut away from deposition substrate 202 through sacrificial portion 222 (see FIG. 4B). Face plate 250 includes four examples of a registration feature 255 that may be used to register the position of face plate 250 with respect to fabrication equipment or a tape-laying machine for PMC manufacturing, as described further below.

FIG. 6 shows a support structure 260 for face plate 250 (FIG. 4C) that may be fabricated independently of face plate 250, according to an embodiment. Support structure 260 may be fabricated by hand welding of component parts, or may be fabricated utilizing additive manufacturing (e.g., by any one of electron beam deposition, wire arc plasma spray, tungsten inert gas and metal inert gas deposition). Independent fabrication of support structure 260 and face plate 250 may save weeks of time in the tooling production process. FIG. 7 is an elevational view of face plate 250 welded in place onto support structure 260 to form a finished die tool 280.

FIG. 8 schematically illustrates a manufacturing cell 300 configured for additive manufacturing of a face plate for PMC manufacturing. Cell 300 includes a substrate manipulator 310 and a deposition manipulator 410 in proximity with one another and under control of a computer 490. Manipulator 310 holds a deposition substrate 202 and manipulator 410 holds a deposition head 230 such that deposition head 230 deposits metal 240 on substrate 202 or on a face plate being built up on substrate 202. Cell 300 may also include one or more optional sensor assemblies 482 for sensing location information of features or surfaces of the face plate being built up.

Manipulator 310 includes a base 305. A rotational stage 320 couples with base 305 and takes a rotational position in the direction of arrow 325 under control of computer 490. A mount 330 on stage 320 includes an axle 340. A base 350 of a second rotational stage 360 takes a rotational position in the direction of arrow 345, about axle 340, under control of computer 490. Second rotational stage 360, holding deposition substrate 202, takes a rotational position in the direction of arrow 355. It can thus be seen that deposition substrate 202 may be, for example, held flat and level to begin a deposition; after a face plate 220 is partially built up, manipulator 310 may reposition deposition substrate 202 and the face plate relative to manipulator 410, so as to position a desired location on either a front surface or a back surface of face plate 220 to receive additional metal 240 from deposition head 230.

Manipulator 410 includes a base 405. A support 420 mounts on base 405 and takes a rotational position in the direction of arrow 425 under control of computer 490. A first arm section 430 couples with support 420 and moves to an angle along the direction of arrow 435 under control of computer 490. A second arm section 440 couples with first arm section 430 and moves to an angle along the direction of arrow 445 under control of computer 490. Second arm section 440 includes a linear transducer 450 that contracts or extends a length of second arm section 440 along the direction of arrow 455 under control of computer 490. Deposition head 230 couples with second arm section 440 and moves to an angle along the direction of arrow 460. Deposition head 230 deposits metal 240 in the direction of an axis 470. Current deposition technology allows a maximum allowable deposition angle 475 between axis 470 and vertical (indicated by line 480) of about 35 degrees; however it is appreciated that advances in deposition technology may increase the maximum allowable deposition angle, providing further manufacturing flexibility.

Optional sensor assembly 482 may include a base 484, an optional manipulator 486 and a sensor 488 that may be, for example, an optical or tactile sensor. Sensor 488 is capable of gathering location information about the face plate being built, in situ on the deposition substrate, for process control purposes as described further below. Sensor 488 may in particular be an optical scanner capable of generating three-dimensional information about the face plate being built. Sensor 488 is controlled by, and sends location information of the face plate to, computer 490.

It is appreciated that the specific mechanical features, and types and ranges of motion of manipulators 310, 410 and 486 are exemplary only, and that other types of fixtures may be utilized to position deposition head 230 and sensor 482 with respect to deposition substrate 202. For example, more or fewer rotational stages or linear transducers may be utilized, or may be utilized in differing ways, than are shown in manipulators 310, 410 and 486. Manipulators 310, 410 and 486 may be fixed to respective bases 305, 405 and 484 as shown, or may be mounted to a common base. Other types of manipulators may be utilized that provide similar or additional degrees of freedom in manipulating a substrate, deposition and/or machining heads, and sensors; in particular gantry type systems may be utilized to facilitate building very large face plates (e.g., face plates measuring 10 feet or more in at least one dimension).

Computer 490 denotes any combination of computers and/or networking resources, and is not limited to being a single computer connected solely to the other components of manufacturing cell 300. Computer 490 may include two or more computers that coordinate activity of individual components of manufacturing cell 300, and/or interface with other computers. For example, computer 490 may interface with a computer aided manufacturing system (not shown) that stores numerical control programs for manufacturing cell 300, downloads such programs to computer 490, and receives quality control information and manufacturing status information from computer 490. Computer 490 may interface with other computers through wired or wireless connections, or over the Internet.

It can be seen from FIGS. 1A through 1E that existing techniques result in piecemeal assembly of a face plate such that only the frontside surface (e.g., the surface intended for PMC layup) is accessible in many cases. But additive manufacturing, especially using equipment like manufacturing cell 300 as shown in FIG. 8, may enable access to both sides of a face plate, such that further useful structures may be integrated with the backside of the face plate (e.g., the side that will eventually be joined with a support structure). Also, face plates manufactured utilizing additive manufacturing may be considerably thinner, resulting in lower weight and thermal mass, than face plates manufactured utilizing prior art techniques. For example, face plates manufactured utilizing current additive manufacturing technology may be a relatively consistent 0.375″ thick, and this number is expected to decrease as experience is gained with additive manufacturing and with process controls associated therewith. By comparison, face plates manufactured utilizing prior art techniques may be anywhere from 0.5″-2.0″ thick, often spanning this range in differing locations on a single face plate, due to the need to overbuild and machine down the face plate to achieve the correct surface. Use of additive manufacturing therefore enables fabrication of PMC die tools with novel and useful structures as compared to die tools made using existing techniques. Examples of such structures are now discussed.

FIGS. 9A and 9B illustrate a face plate 500 for PMC manufacturing, for example as manufactured using cell 300, FIG. 8. FIG. 9A is a top perspective view of a frontside surface 510 of face plate 500. FIG. 9B is a bottom perspective view of a backside surface 520 of face plate 500. As shown, backside surface 520 is crisscrossed with integral stiffening structure in the form of ribs 530 that add structural stability to face plate 500. Face plate 500 may be on the order of 12 to 15 feet in each of length and width; stiffening ribs 530 for a structure of such size may be in the range of 12 to 36 inches apart. Given the lighter weight of face plate 500 as compared to a tool face made by existing methods, stiffening ribs 530 may be sufficient to ensure structural stability of face plate 500 through tape layup and curing during PMC manufacturing, and may require only minimal support. It is appreciated that the orthogonal grid design of ribs 530 shown in FIG. 9B may be replaced with an isogrid design as that term is known in the art, for example an array of stiffening ribs 530 laid out in a triangular pattern so as to distribute applied stresses in all directions. Furthermore, stiffening structure is not limited to ribs with rectangular cross-sections as shown in FIG. 5B. For example, stiffening structure with a cross-section forming an L-shape, a triangle shape, a partial or complete hexagon, or a mixture of such shapes may be utilized. When utilized, stiffening structure is typically 1 to 3 inches deep (that is, extends from the surface being stiffened by this amount) with larger depths being associated with larger tools. Width of stiffening structure may be as little as 0.1 or 0.05 inches.

FIGS. 10 and 11 illustrate a face plate 500′ for PMC manufacturing and a corresponding support structure 550. FIG. 10 is a bottom perspective view of a backside surface 520′ of face plate 500′. Tool face 500′ is in all respects identical to face plate 500, FIG. 9B, with the addition of attachment points 540. Attachment points 540 may be built up on backside surface 520′ in the same manner as stiffening ribs 530, 530′ during additive manufacturing of face plate 500′. As an alternative to a support structure that is permanently welded to a face plate, attachment points 540 may be integrated with face plate 500′ such that they are at standard locations in space, so that a support structure can be utilized with different face plates (that is, face plate 500′ and face plates of other designs but similar overall dimensions). FIG. 11 shows a support structure 550 that includes attachment points 560. Each attachment point 540 of face plate 500′ corresponds with one of attachment points 560 of support structure 550 so that when in use for PMC manufacturing, face plate 500′ may couple with and be supported by support structure 550. When not in use, face plate 500′ may detach from support structure 550 so that a different face plate may be used with support structure 550.

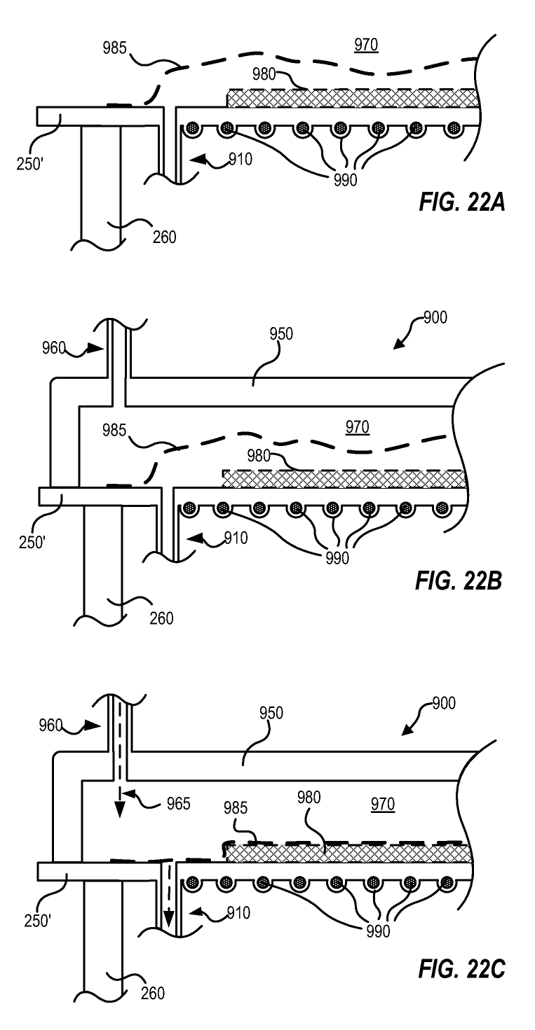

FIGS. 12A through 12D illustrate buildup of closed channels 630 on a backside 604 of a face plate 600. Closed channels 630 may be utilized to carry fluids during PMC fabrication, to heat and/or cool face plate 600, in order to improve heat equalization throughout the die tool and layup material during temperature ramps. Improved heat equalization may, in turn, help minimize thermal stresses on the die tool and the structure being fabricated, and may facilitate more rapid heating and cooling, to reduce manufacturing time and cost. Closed channels 630 may even be used to substitute in situ heating and cooling through the face plate during PMC manufacturing, for heating and cooling in an autoclave, as practiced in the prior art (also see FIGS. 22A and 22B). Closed channels 630 may also act as stiffening ribs, discussed above, that help stiffen the die face so that associated support structures may be minimized or eliminated.

In FIG. 12A, face plate 600 is held (e.g., by manipulator 310, FIG. 8) with a tool face 602 facing downwards, while a deposition head 230 selectively adds metal 240 to backside 604, forming initial channel sides 610 that protrude from face plate 600 as shown. In FIG. 12B, face plate 600 is tilted in the direction of arrow 612 so that deposition head 230 can selectively add further metal 240, forming leftwardly curved channel sides 620(a) from two of the initial channel sides 610. In FIG. 12C, face plate 600 is tilted in the direction of arrow 614 so that deposition head 230 can selectively add further metal 240 to form rightwardly curved channel sides 620(b) from two other initial channel sides 610. In FIG. 12D, face plate 600 tilts vertically, in the direction of arrow 616, so that deposition head 230 can selectively add further metal 240 that joins channel sides 620(a) and 620(b) to form channels 630. It is appreciated that once a channel 630 is a closed shape, as shown in FIG. 12D, face plate 600 may be rotated so that an end of channel 630 faces deposition tool 230 and more metal 240 can be added to increase a length of channel 630 along backside 604.

As noted above, successful use of a die tool for PMC manufacturing may rely in part on ability of an automated tape-laying machine to register with high mechanical precision to registration features of the die tool. Once the tape-laying machine registers to the one or more registration features, it can execute a program that lays out prepreg tape on the die face in a predetermined pattern. A strategy for providing registration features is therefore needed. Currently, typical additive manufacturing techniques generate features with an accuracy and surface finish smoothness of about 0.1 inch, but typical PMC manufacturing requires tape-laying registration to about 0.01 inch accuracy, and surface finish to about 32 rms smoothness. Methods of generating registration features are now described. It is appreciated that the specific methods described will suggest, to those of ordinary skill in the art, similar ways of facilitating registration of die face features to fabrication equipment for die tooling and/or fabrication equipment for PMC manufacturing.

One method 700 of generating registration features is shown in FIG. 13A. It is appreciated that steps of method 700 may be interspersed with manufacturing steps in a variety of combinations, and that such manufacturing steps are not necessarily shown, although exemplary steps are shown in dashed boxes. The steps of method 700 can also be performed, in some cases, in an order other than shown in FIG. 13A. A first step 705 of method 700 provides a deposition substrate having location markers. For example, deposition substrate 202 (see FIGS. 4A, 4B, 4C and 8) may have location markers inscribed onto or machined into it when initially positioned in an additive manufacturing cell (e.g., mounted onto manipulator 310 of cell 300, FIG. 8). In step 710, the manufacturing cell registers position of the location markers relative to its own coordinate system, e.g., by placing the deposition substrate in an approximate position and utilizing machine vision to find the location markers, or by loading the deposition substrate in mechanical or visual alignment. In step 715, the face plate is fabricated, e.g., by additive manufacturing that builds upon the deposition substrate, as shown in FIGS. 3, 4A, 4B, 4C and 8. The fabrication step results in the face plate being welded to the deposition substrate in a known position relative to the location markers on the substrate, but only to the precision afforded by the additive manufacturing process.

At this point, several options are possible. One option is simply leaving the deposition substrate in the manufacturing cell for subsequent operations; this has the advantage of simplicity and avoiding any error in re-registering the deposition substrate to the cell. For example, the face plate may be left in place and the deposition head may be replaced by a machining head, in optional step 720. Another option is to dismount the deposition substrate in optional step 725 and mount it again in the same manufacturing cell, or a different cell, in optional step 730. In either case, the removal and remounting necessitates registering the location markers on the deposition substrate to the cell in which the substrate mounts, in optional step 735. Also optional are whether a machining head mounts onto the same manipulator that held the deposition head for fabrication, or whether a different manipulator is utilized. In either of these cases, it is presumed that the machining head is registered to the coordinate system of the manufacturing cell.

In step 740, with the face plate registered to the same or a different manufacturing cell, a machining head of the manufacturing cell generates the registration features. For example, the surface of the face plate that forms the final die face may be machined smooth, and registration features machined into the smooth surface (perhaps in a periphery of the face plate, where features of the registration features will not be in contact with prepreg when used in PMC manufacturing). In another example, a backside of the face plate, or support structures fabricated on the backside, may be machined smooth in area(s) large enough to place registration features, and the registration features are subsequently machined to the smoothed areas. The machining of registration features achieves the required accuracy because the machining head is registered to the manufacturing cell, and thus registered to the location points on the deposition substrate. At this point, further machining of the face plate may occur in optional step 742. Location of features on the face plate is known to the manufacturing cell, and data relating position of such features relative to the registration features may be stored. Finally, the face plate is removed from the deposition substrate in step 744, generally by cutting it away. This destroys the registry of the face plate to the location markers on the deposition substrate, but the registration features on the face plate itself can take over the function of providing known locations on the face plate for registration of the die face features to further machine tools and/or a tape-laying machine.

Another method 750 of generating registration features is shown in FIG. 13B. It is appreciated that steps of method 750 may be interspersed with manufacturing steps in a variety of combinations, and that such manufacturing steps are not necessarily shown, although exemplary steps are shown in dashed boxes. The steps of method 750 can also, in some cases, be done in an order other than shown in FIG. 13B. An optional first step 752 generates registration features in a deposition substrate. These registration features may be mechanical (e.g., edges or holes whose position is known with precision), visual (e.g., fiducial marks whose position is known with precision) or both. A step 755 of method 700 fabricates a face plate utilizing deposition and/or machining heads of a manufacturing cell. It is typical, but not mandatory, to do at least rough machining of the face plate in step 755. A usual, but optional, step 760 utilizes a machining head of the manufacturing cell to generate registration features in the face plate. Step 760 may machine the registration features at arbitrary locations, that is, locations whose location relative to intended final die face features is not known with high precision at the time that step 760 is performed. Step 765 “locates” the face plate utilizing optical scanning equipment. Such equipment may be part of the manufacturing cell utilized in steps 755 and/or 760 (e.g., sensor 488, FIG. 8) or may be a separate tool. The optical scanning equipment builds a high precision, three-dimensional data “image” of the face plate, including any registration features already machined into the face plate (in step 760) and/or in the deposition substrate (in step 752). If machining of the face plate is essentially complete from step 755, and registration features were created in step 760, then step 765 may create final offset data relating position of features of the face plate to position of the registration features. If machining of the face plate is not complete, but step 760 created registration features, then step 765 may facilitate creation of further machining recipes of the face plate by generating a map of metal thickness to be removed by further machining If the face plate is in a raw, deposited state from step 755 and step 760 was omitted, then step 760 locates the face plate relative to the registration features in the deposition substrate, created in step 752. Step 770 utilizes the machining head of a manufacturing cell to generate registration features on the face plate, instead of or in addition to any registration features generated at step 760. It is appreciated that step 770 may utilize the same manufacturing cell as in steps 755 and/or 760, or may utilize a different manufacturing cell, as discussed between steps 710 and 715 of method 700, FIG. 13A. Further machining of the face plate may also, occur in a further optional step 772.

One scenario that can occur in many manufacturing processes, including additive manufacturing, is that small variations in positions of multiple features add up to create a positional shift that can exceed a dimensional tolerance of a finished product. This can occur, for example, when one piece part after another is serially attached to an initial structure (wherein the positional shift is sometimes referred to as “stack-up” error), or in additive manufacturing, when layer after layer of material is added to a structure as it is built up from a deposition substrate. However, additive manufacturing can be implemented so as to minimize and/or correct for such variations. For example, a manufacturing cell can include tactile and/or optical sensor assemblies (e.g., sensor assembly 482 of manufacturing cell 300, FIG. 8). Such sensors may be precisely registered to the coordinate system used by the manufacturing cell, or may detect registration features of a deposition substrate or an object being built, such that location information sensed by the sensors can be directly correlated to positioning commands for any one of a substrate holder or a deposition or machining head.

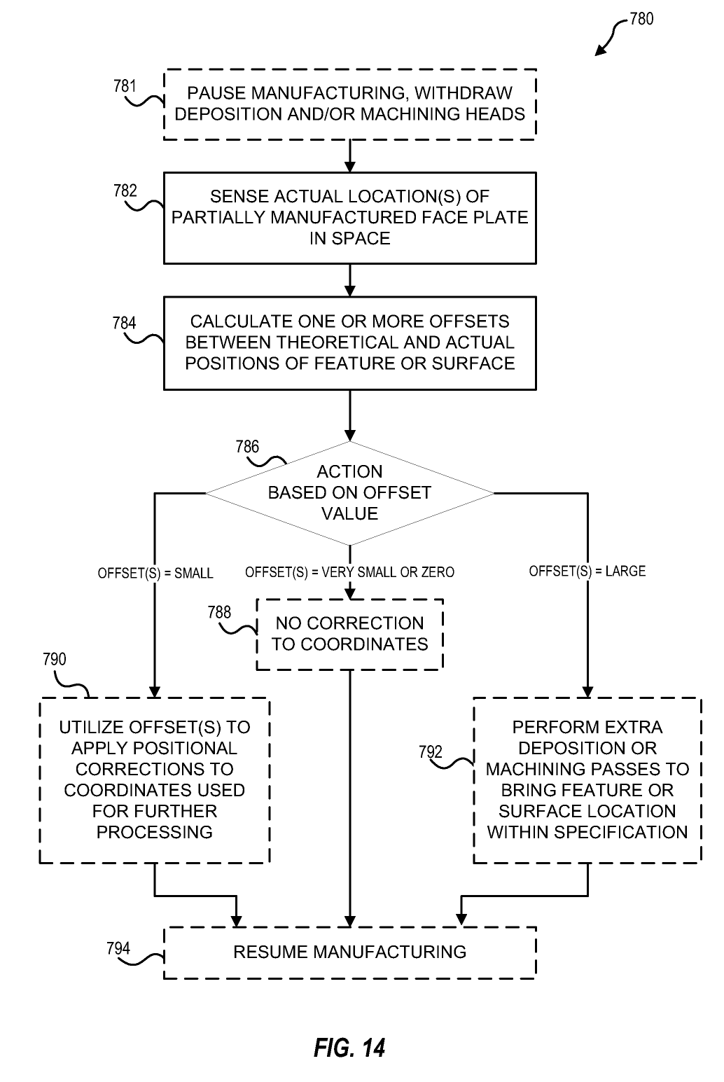

FIG. 14 is a flowchart of a manufacturing method 780 that utilizes in-process feedback to modify an additive manufacturing process to correct for positional shift in a face plate being built. Method 780 may be performed periodically during additive manufacturing and/or machining, for example, in conjunction with steps 110, 120 and/or 160 of method 100 (FIG. 2 and FIG. 3), steps 715 and/or 742 of method 700 (FIG. 13A), or steps 755 and/or 772 of method 750, FIG. 13B. In a first, optional step 781 of method 780, manufacturing pauses and deposition or machining heads are withdrawn from the vicinity of the face plate being made. It may not always be necessary to execute step 781, but it may be preferable, so that the face plate can be accessed by sensors. In step 782 of method 780, optical and/or tactile sensors (e.g., sensor 488, FIG. 8) sense one or more actual location(s) of the partially manufactured face plate in space, and pass sensed location information to a system controller (e.g., computer 490, FIG. 8). The sensed location information from the sensors provides knowledge of where features or surfaces of the object are, as compared to theoretical locations where such features or surfaces “should be” according to the deposition (and/or machining) that has been done. In step 784, the system controller calculates offsets between the theoretical and actual positions of features or surfaces. In one example of steps 782 and 784, a tactile sensor 488 may measure the location of the face plate at one or more predetermined spatial locations, and computer 490 may calculate the difference between the actual measured locations and their theoretical locations. In another example of steps 782 and 784, an optical sensor 488 may acquire a full optical scan of the partially manufactured face plate, and computer 490 may determine the actual location of an entire surface and calculate the point by point deviation of the surface from the theoretical surface. In step 786, the system controller determines an action to be taken based on one or more such offsets. In a first case 788, when the calculated offsets are zero or very small, no action is taken and deposition or machining resumes without adjustment. In a second case 790, when the calculated offset(s) are greater than in step 788 but are still small, the offsets may be utilized to apply positional corrections to the coordinates used for further processing, so that the shape of the object is corrected as it is built up, instead of growing further away from its intended shape. In a third case 792, when the calculated offset(s) are large, (e.g., the offsets may predict that the surface of the final die face is not within the existing deposited material, or at least lacks sufficient machining tolerance) extra deposition or machining passes are performed to add or remove material to bring the feature or surface within specifications. The criteria utilized to decide whether calculated offsets are “very small,” “small” or “large” are matters of design choice and of knowledge and skill acquired by the personnel that set up and run the manufacturing cell. After the coordinate corrections and/or extra deposition or machining passes of steps 790 or 792, manufacturing resumes (if it was paused at all) in step 794.

Intervals of manufacturing between executions of method 780 can be tailored for fewer measurements and high throughput, for noncritical or less technique sensitive items, or for more measurements and lower throughput, for more critical or more technique-sensitive items. Such intervals can even be calculated dynamically, that is, a history of several measurements can be used to estimate the likelihood of the product being made varying from the intended shape, and therefore to schedule further sensing and calculating steps more or less frequently. Offset information may be stored by the system controller and/or shared with other information processing tools for statistical quality control and die tool qualification purposes. Also, it should be noted that method 780 provides for sensing and corrections either during deposition or machining, but currently the primary benefits of method 780 are expected to occur during deposition. This is because (a) there is a higher probability of deposited material having positional variation during deposition than removed material having positional variation during machining, and (b) deposition inherently involves higher temperatures than machining, so it involves an increased possibility of warpage or material softening leading to deformation of the face plate.

It is appreciated that the modalities described herein are adaptable to support new designs or design changes on short notice, which in turn may allow a designer additional time to perfect or simulate a design before committing to the design, e.g., because fabrication must start to maintain a prototype schedule. Such changes may be implemented in one of two ways: (1) If a change is made before a die tool is to be made, the die tool is simply made to the changed design. The reduced cycle time for tool manufacturing can be utilized as increased time for designing, modeling and refining the design of the finished part. (2) If a change is made to a limited part of a die tool after the die tool is partially or completely made, the die tool can be affixed to a manipulator of a manufacturing cell, the location of the die tool can be registered to the manufacturing cell (as per steps of FIG. 13A and/or FIG. 13B), any fabricated portion of the die tool that has been changed can be removed from the die tool if necessary (e.g., by machining away metal until the remaining metal is common to the old and new designs), and a new portion can be added to the die tool to implement the change.

The techniques described herein are also adaptable to support repair of damaged PMC parts in certain cases. For example, when damage to a PMC panel is localized (e.g., chipped or pierced due to high speed impact of an object, such as an aircraft panel suffering a bird strike, or battle damage), a custom die face may be fabricated on short notice to repair just the damaged area of the panel. While it may also be possible to utilize an die tool that originally formed the panel for repair purposes, this may be impractical because for example the panel needing repair may be in one part of the world (e.g., the United States) while the original die tool may be in another part of the world (e.g., China) and/or may be scheduled for continuous use in making new panels. The die tool would certainly be expensive to ship to another location for repair, but if removable, the panel could be sent over a moderate distance to a repair facility where a custom die tool can be made to place over or onto the damaged panel, enabling an in situ repair of the PMC panel by adding PMC material. If the panel is not removable but the location of the damage can be located on the panel, a die tool for a custom patch can be made. The design database can easily be sent as needed to a repair facility having additive manufacturing capability to provide a specification of die face features, or the damaged panel itself can be optically scanned to provide surface information from which an appropriate surface for the damaged area can be estimated or interpolated. The two techniques discussed above are now described in further detail.

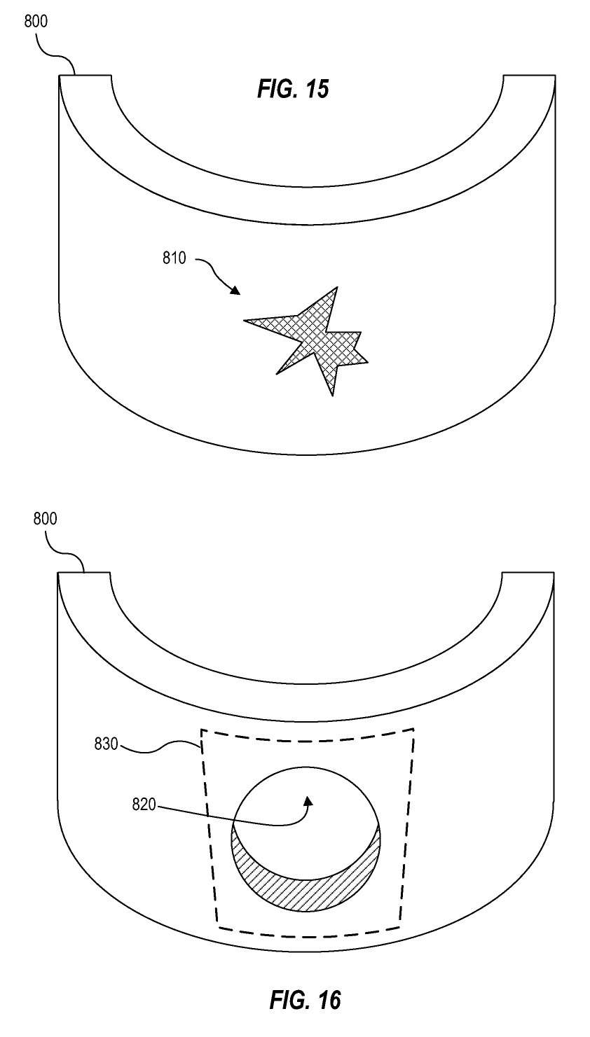

FIG. 15A is a perspective view illustrating a PMC panel 800 having a damaged area 810. FIG. 16 shows panel 800 with damaged area 810 machined out to present a “clean” hole 820 through panel 800, although such machining may not always be necessary for a successful PMC repair. FIG. 16 also shows an area 830 identified as a target area for a patch to be formed in part using a custom die face.

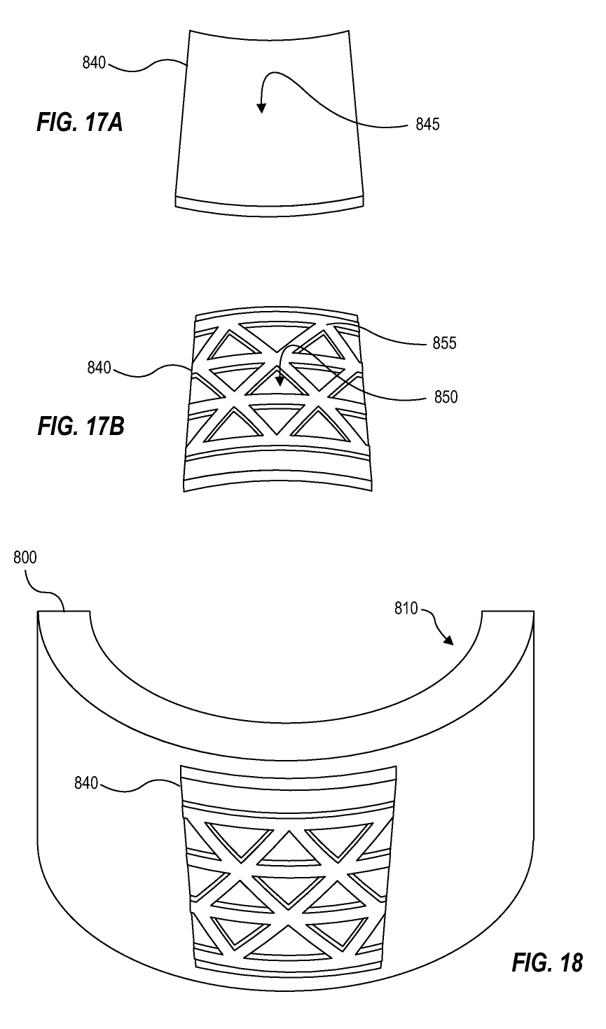

FIG. 17A is a perspective view of a custom die tool 840 having a repair surface 845. Die tool 840 is produced by additive manufacturing by building a die that reproduces the original surface of the die tool that manufactured panel 800, but only over area 830, FIG. 15B. FIG. 17B is a perspective view of die tool 840 that shows its backside 850, including an isogrid stiffening structure 855 integrated therewith.

FIG. 18 shows die tool 840 in place over area 830; with die tool 840 in place, new prepreg (behind die tool 840, in the view of FIG. 18) can be placed into hole 820 (FIG. 15B) and cured in situ to form a patch for panel 800.

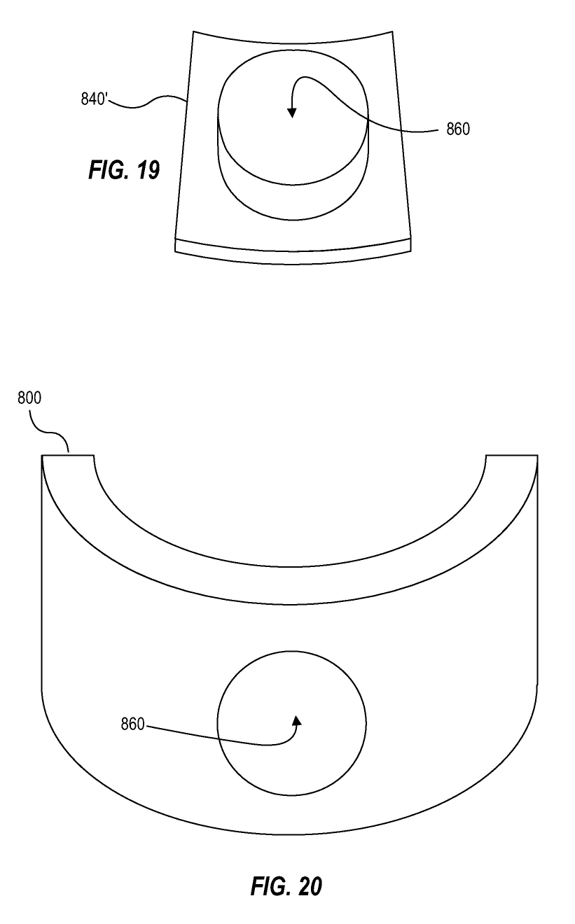

FIG. 19 shows a die tool 840′ being utilized to fabricate a custom patch 860 for panel 800. Die tool 840′ may differ from die tool 840 in that they provide the same surface shape for a patch for panel 800, but may have different features (such as, for example, vacuum fittings) since surface 845 of die tool 840 is in contact with panel 800 while die tool 840′ is essentially being utilized in the same way as a die tool would be during original manufacture of a PMC component. Patch 860 may be fabricated slightly larger than hole 820 in panel 800 so that edges of patch 860 and/or hole 820 can be machined down to provide an exact fit. FIG. 20 shows patch 860 installed in panel 800; techniques for installing patch 860 may include but are not limited to use of adhesives such as epoxy, and/or bracing patch 860 to internal structural components that also brace panel 800.

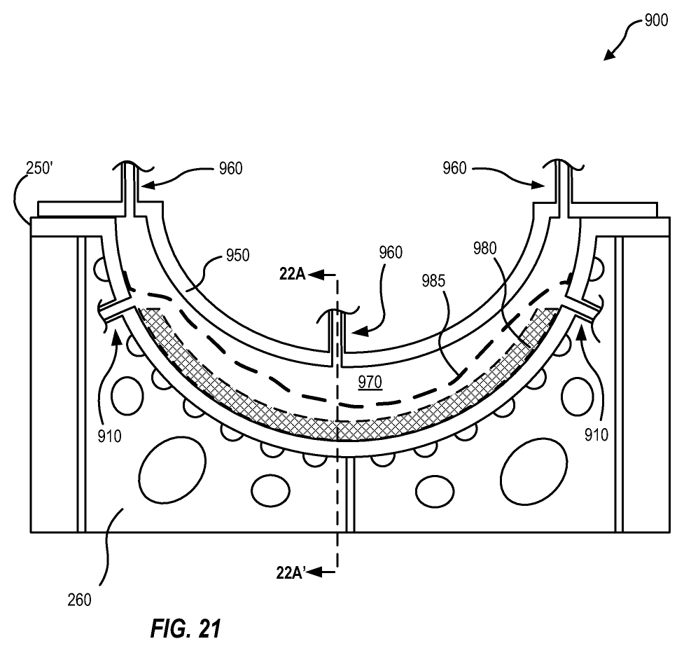

FIG. 21 illustrates a die tool 900 being utilized in a PMC manufacturing process to illustrate embodiments of utilizing a die tool. Die tool 900 utilizes heating and cooling capability provided by closed channels on a face plate backside, and/or pressure added through use of a mating enclosure, as a substitute for use of an autoclave to provide heating, cooling and pressure. Die tool 900 includes support structure 260, and a face plate 250′ that is similar to face plate 250 (FIG. 5 and FIG. 7) with the additional features of heating/cooling channels and vacuum ports 910, described below. Die tool 900 further includes mating enclosure 950 that mates with face plate 250′ to form a pressure tight seal and create a cavity 970 therebetween. Mating enclosure 950 also forms pressure ports 960 for elevating pressure within cavity 970. FIG. 21 also shows prepreg material 980 and a vacuum bag 985 as they would be positioned during PMC manufacturing to form and cure prepreg material 980 into a molded composite product. A cross-sectional line 22A, 22A′ shows the location of a view shown in FIGS. 22A and 22B. Air may be alternatively evacuated from or pumped into cavity 970 through ports 910 and 960 respectively, as described below.

FIG. 22A, FIG. 22B and FIG. 22C illustrate details of die tool 900 along the cross-sectional line 22A, 22A′ of FIG. 21, as used during PMC manufacturing. Face plate 250′ forms vacuum port 910 and closed heating/cooling channels 990, as shown. During PMC manufacturing, prepreg material 980 is placed on face plate 250′ by a tape laying machine, and vacuum bag 985 is placed over the prepreg material and sealed to edges of face plate 250′, as shown in FIG. 22A. Mating enclosure 950 seals to face plate 250′ in FIG. 22B. A vacuum is drawn through vacuum port 910, as shown in FIG. 22C, causing atmospheric pressure above vacuum bag 985 to press vacuum bag 285 against prepreg material 980, pressing in turn against face plate 250′. Optionally, a pressurizing gas 965 (e.g., air, but other gases could be used) is pumped into cavity 970 through pressure port 960 to further compress vacuum bag 285 and prepreg material 980 against face plate 250′. In addition to, or instead of utilizing mating enclosure 950, a heated fluid may be introduced through heating/cooling channels 990, to heat die tool 900 to a high temperature to cure prepreg material 980. The high temperature fluid is typically a liquid, but may be a gas. After prepreg material 980 is cured, high temperature fluid flow ceases, or is alternatively replaced by cooling fluid (or gas), to bring down the temperature of die tool 900 in a controlled fashion. In this manner, utilizing mating enclosure 950 to add pressure to the backside of the prepreg during curing circumvents the need to place a die tool in a large and expensive autoclave to cure prepreg material. Similarly, even if extra pressure is not needed, the in situ die tool temperature control achievable with heating/cooling channels 990 may avoid the need to place the die tool in a large and expensive oven. A mating enclosure 950 may also include heating/cooling channels and/or stiffening structure to help achieve rapid and uniform temperature changes and to maintain dimensional stability of a polymer matrix composite article during fabrication.

The configurations shown in FIGS. 21, 22A, 22B and 22C will suggest numerous variations to one skilled in the art of PMC manufacturing. In particular, it is contemplated that a number, size and layout density of heating/cooling channels 990 may be increased or decreased to provide sufficient and uniform heating and cooling for die tool 900. Vacuum bag 980 may seal to face plate 250′ as shown, or may seal to a periphery of mating enclosure 950. Pressurizing gas 965 may be preheated and/or cooled to assist with heating and/or cooling of die tool 900. Specific ones of channels 990 may be separately dedicated for heating or cooling, or the same channels may be utilized for heating at certain times and cooling at other times.

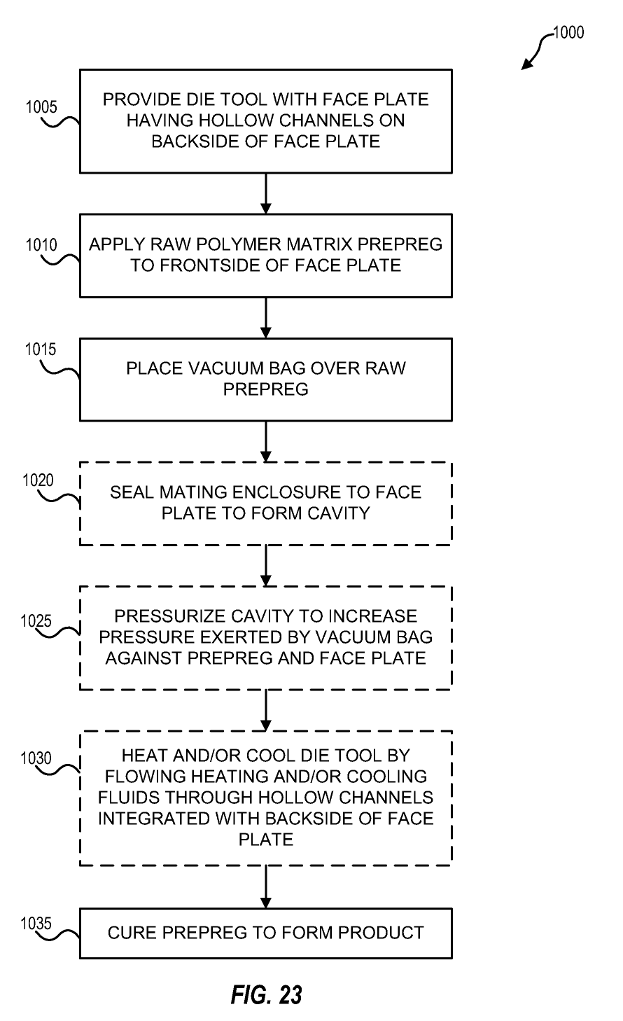

FIG. 23 is a flowchart of a method 1000 for producing a polymer matrix composite product. Step 1005 provides a die tool with a face plate that has hollow channels on a backside thereof. An example of step 1005 is providing a die tool such as die tool 900, FIG. 21. Step 1010 applies raw polymer matrix composite material (prepreg) to a frontside of the face plate. An example of step 1010 is applying prepreg material 980 to face plate 250′, FIG. 21. Step 1015 places a vacuum bag over the raw prepreg material. An example of step 1015 is placing vacuum bag 985 over prepreg material 980, FIG. 21. Optional step 1020 seals a mating enclosure to the face plate to form a cavity therebetween. An example of step 1020 is sealing mating enclosure 950 to face plate 250′ of die tool 900, FIG. 21, thus forming cavity 970. Optional step 1025 pressurizes the cavity to increase pressure exerted by the vacuum bag against the prepreg and the face plate. An example of step 1025 is pumping pressurizing gas 965 into cavity 970, FIG. 21. An optional step 1030 heats and/or cools the die tool by flowing heating and/or cooling fluids through the hollow channels. An example of step 1030 is passing heating and/or cooling fluids through heating/cooling channels 990, FIG. 21 or through similar heating/cooling channels in mating enclosure 950. Step 1035 cures the prepreg to form the product; it is appreciated that curing may happen in parallel with pressurization step 1025 and/or heating and/or cooling steps 1030 as required to cure the specific type of prepreg being utilized.

The changes described above, and others, may be made in the die tool fabrication methods described herein without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for producing a die tool, comprising:
forming a substantially complete face plate of the die tool utilizing an additive manufacturing process;
forming a support structure of the die tool independently from the face plate; and
coupling the face plate with the support structure to form the die tool.

2. The method of claim 1, the step of forming the face plate of the die tool comprising depositing Invar.

3. The method of claim 1, the step of forming the face plate comprising utilizing one of electron beam deposition, wire arc plasma spray, Tungsten inert gas and metal inert gas as the manufacturing process.

4. The method of claim 1, further comprising a step of rough machining the face plate.

5. The method of claim 4, wherein the step of forming the substantially complete face plate is performed on a piece of equipment that utilizes a deposition head, and wherein the step of rough machining is performed on the same piece of equipment, utilizing a machining head instead of the deposition head.

6. The method of claim 1, the step of forming the face plate comprising forming registration features on a backside of the face plate.

7. The method of claim 6, further comprising a step of aligning the face plate to the support structure, utilizing the registration features, before the step of coupling the face plate with the support structure.

8. The method of claim 1 wherein the step of coupling comprises welding the face plate to the support structure.

9. The method of claim 1 wherein the step of forming the support structure comprises forming an interchangeable support structure and the step of coupling comprises removably coupling the face plate with the support structure.

10. The method of claim 1, the step of forming the face plate comprising forming stiffening structure on a backside of the face plate.

11. The method of claim 10, the stiffening structure comprising one or more hollow channels.

12. The method of claim 1, wherein the step of forming the support structure comprises forming the support structure such that a ratio of weight of the support structure to weight of the die tool is less than 0.33.

13. The method of claim 12, wherein the ratio of weight of the support structure to weight of the die tool is less than 0.20.

14. A die tool for use in composite manufacturing, comprising:
a face plate; and
stiffening structure integrated with the face plate, the stiffening structure forming one or more hollow channels configured for transport of fluid for at least one of heating and cooling during the composite manufacturing.

15. A die tool for use in composite manufacturing, comprising:
a face plate; and
a support structure coupled with the face plate, a ratio of weight of the support structure to weight of the die tool being less than 0.33.

16. The die tool of claim 15, the ratio of weight of the support structure to weight of the die tool being less than 0.20.

17. In a method of producing a die tool that includes a face plate and a support structure, an improvement comprising:
independently forming
(a) a substantially complete face plate of the die tool, utilizing an additive manufacturing process, and
(b) a support structure of the die tool; and
coupling the face plate with the support structure to form the die tool.

18. A method of producing a polymer matrix composite product, comprising:
forming a substantially complete face plate of a die tool utilizing an additive manufacturing process, the face plate having stiffening structure, comprising one or more hollow channels, on a backside thereof;
applying raw polymer matrix composite material to a frontside of the face plate; and
flowing a fluid through the one or more hollow channels to heat or cool the die tool, thereby curing the polymer matrix composite material to form the product.

19. The method of claim 18, wherein forming the substantially complete face plate comprises forming hollow channels as the stiffening structure.

20. The method of claim 18, wherein flowing the fluid comprises heating or cooling the die tool in accordance with a controlled temperature schedule.

21. A method of producing a polymer matrix composite product, comprising:
applying raw polymer matrix composite material to a frontside of a face plate of a die tool;
placing a vacuum bag atop the polymer matrix composite material;
sealing a mating enclosure to the face plate, such that a seal between the face plate and the mating enclosure circumscribes a periphery of the polymer matrix composite material, to form a cavity between the face plate and the mating enclosure; and
pressurizing the cavity so as to increase pressure exerted by the vacuum bag against the polymer matrix composite material and the face plate, while the polymer matrix composite material cures to form the product.

22. The method of claim 21, further comprising flowing a fluid through the one or more hollow channels integrated with a backside of the face plate, to heat or cool the die tool and thereby cure the polymer matrix composite material.

23. The method of claim 22, wherein flowing the fluid comprises heating or cooling the die tool in accordance with a controlled temperature schedule.

24. The method of claim 21, further comprising providing the die tool, by:
forming a substantially complete face plate of the die tool utilizing an additive manufacturing process;
forming a support structure of the die tool independently from the face plate; and
coupling the face plate with the support structure to form the die tool.

25. The method of claim 24, wherein forming the substantially complete face plate comprises forming one or more hollow channels integrally with forming the die tool in the additive manufacturing process.
